(19) United States
(12) Patent Application Publication
(10) Pub. No.: US 2026/0287117 A1
(43) Pub. Date: Sep. 24, 2026

(54) SELF-ADJUSTING LUBRICATION SYSTEM

(71) Applicant: AKTIEBOLAGET SKF, GOTEBORG (SE)

(72) Inventors: Filipe COUTINHO, Utrecht (NL); Sebastien DAVID, Ouderkerk aan de Amstel (NL)

(21) Appl. No.: 19/561,671

(22) Filed: Mar. 10, 2026

(30) Foreign Application Priority Data
Mar. 19, 2025 (DE) 102025110634.7

(51) Int. Cl. F16N 29/02

(52) U.S. Cl. CPC F16N 29/02; F16N 2250/04; F16N 2250/11; F16N 2270/30

(57) ABSTRACT

A lubrication system includes an automatic lubricator configured to feed a controllable dose of lubricant to a lubrication point of a machine, a visual recognition system configured to acquire at least one image of the machine, and a microcontroller configured to communicate with the visual recognition system and with the automatic lubricator. The visual recognition system is configured to send at least one image signal to the microcontroller, the at least one image signal containing information about at least one appearance of the machine. The microcontroller is configured to send at least one control signal to the automatic lubricator to adjust at least one lubrication parameter of the automatic lubricator based on the at least one control signal.

### CROSS-REFERENCE

This application claims priority to German patent application no. 10 2025 110 634.7 filed on Mar. 19, 2025, the contents of which are fully incorporated herein by reference.

### TECHNOLOGICAL FIELD

The present disclosure relates to a lubrication system, specifically a lubrication system configured to supply a rolling bearing with a proper amount of lubricant.

### BACKGROUND

Improperly configured lubrication systems are often found on the field and are leading to under- or over-greasing of rolling bearings or other mechanical parts. Most times, the settings of those lubrication systems are set randomly or are based on a first estimation from the installation team of the lubrication systems.

Users may have trouble selecting the correct settings of a lubrication system as they are not aware of all the required application parameters to fully take advantage of the possibilities of the lubrication system. Ultimately, users may also lack the proper know-how or resource availability to properly do so. Consequently, the misuse of a lubrication system increases the grease waste and makes a proper lubrication uncertain, leading to a higher maintenance cost.

### SUMMARY

The present lubrication system addresses these challenges by providing an easy to use and easy to setup automated solution for the lubrication of mechanical systems.

This automated solution is designed to reduce grease waste, to apply the correct amount of grease, to automatically adjust to operating conditions, to reduce the need for visual inspection and to cope with the usual lack of maintenance resources while improving the effectiveness of the lubrication cycle in order to maximize bearing performance.

Meanwhile, the present solution ensures that the lubrication cycle is automatically adjusted when required, especially in hard-to-access or safety-critical situations or areas, in order to protect the health of workers and operators.

The disclosure relates to a lubrication system comprising an automatic lubricator comprising dosing means for feeding lubricant to a lubrication point of a machine. The lubrication system also comprises a visual recognition system and a microcontroller unit. The microcontroller unit may include a programmable hardware component such as a processor, a computer processor (CPU = central processing unit), an application-specific integrated circuit (ASIC), an integrated circuit (IC), a computer, a system-on-a-chip (SOC), a programmable logic element, or a field programmable gate array (FGPA) including a microprocessor.

The visual recognition system may or may not be integrated in the automatic lubricator. The visual recognition system may be an external device or a phone comprising a camera that is linked to the rest of the lubrication system.

The dosing means are configured to adjust lubrication parameters in response to a control signal sent by the microcontroller unit depending on images of the machine taken by the visual recognition system. With this lubrication system, an operator is now able to ensure the correct dispensing settings for the lubricator, regardless of his level of knowledge. Additionally, the setting up of the automatic lubrication solution becomes much quicker, not requiring pre-calculations.

Furthermore, current solutions are not capable of automatically setting up and adjusting a wide number of lubrication parameters based on measured operating conditions and visual recognition data unlike the present disclosure. The visual recognition system is configured to recognize a machine or a mechanical part of a machine by machine learning and with the assistance of a database, the database comprising the lubrication recommendations for the machine which will be sent as a control signal by the microcontroller unit.

The visual recognition system may also be configured to recognize the environment, preferably the location and/or the industry type, and/or the amount of dust and/or humidity by machine learning and with the assistance of a database, the database comprising the lubrication recommendations which will be sent as a control signal by the microcontroller unit.

Advantageously, the lubrication system comprises a manual input module configured to collect data entered manually by an operator, the control signal sent by the microcontroller unit depending on data collected by the manual input module. Advantageously, the data collected by the manual input module and/or the visual recognition system comprise a bearing type and/or a rotation speed of a bearing of the machine.

According to one aspect of the disclosure, the lubrication system comprises at least an internal sensor configured to measure a backpressure applied to lubricant, and/or a motor current applied to a motor of the automatic lubricator, and/or an ambient temperature around the lubrication system, and/or a battery voltage applied by a battery powering the lubrication system, the control signal sent by the microcontroller unit depending on data collected by the internal sensor.

According to one aspect of the disclosure, the lubrication system comprises at least an external sensor connected to the microcontroller unit, the external sensor comprising a global positioning system measuring the position of the machine, and/or a vibration sensor positioned on the machine, and/or an ultrasonic sensor positioned on the machine, and/or a load measurement sensor positioned on the machine, the control signal sent by the microcontroller unit depending on data collected by the external sensor. The combination of both internal and external sensors ensures the accuracy of the measurements.

Advantageously, the lubrication system comprises a remote monitoring platform wirelessly connected to the automatic lubricator and the microcontroller unit. Wireless connectivity provides the necessary flexibility to implement this solution in a wide variety of assets, as well as the capability to monitor the status of the system remotely. Advantageously, the lubrication parameters comprise the selection of the right lubricant, and/or the lubrication dispense rate, and/or the period of activity of the automatic lubricator.

In one aspect a lubrication system incudes an automatic lubricator configured to feed a controllable dose of lubricant to a lubrication point of a machine, a visual recognition system configured to acquire at least one image of the machine, and a microcontroller configured to communicate with the visual recognition system and with the automatic lubricator. The visual recognition system is configured to send at least one image signal to the microcontroller, the at least one image signal containing information about at least one appearance of the machine. The microcontroller is configured to send at least one control signal to the automatic lubricator to adjust at least one lubrication parameter of the automatic lubricator based on the at least one control signal.

The disclosure also relates to a lubrication method of a machine by a lubrication system as previously defined, the method comprising launching a lubrication cycle based on data collected at least by the visual recognition system and/or by the manual input module, and adapting the lubrication cycle based on backpressure, and/or vibration readings, and/or load readings, and/or bearing housing temperature, and/or battery consumption, and/or humidity and/or data collected by the visual recognition system.

### BRIEF DESCRIPTION OF THE DRAWINGS

The present disclosure and its advantages will be better understood by studying the detailed description of specific embodiments given by way of non-limiting examples and illustrated by the appended drawings on which:

FIG. 1 is a schematic view of the lubrication system according to an embodiment of the disclosure.

FIG. 2 is a flowchart of steps of the lubrication method according to an embodiment of the disclosure.

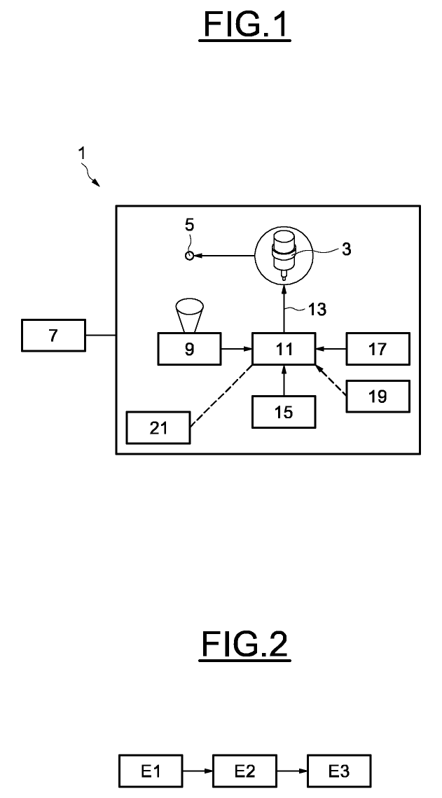

### DETAILED DESCRIPTION

The lubrication system 1 comprises an automatic lubricator 3 configured to supply lubricant to a lubrication point 5 of a machine, for example to a lubrication point 5 of a bearing of the machine. The lubrication system 1 may include a battery 7 powering the lubrication system 1. The lubrication system 1 also includes a visual recognition system 9 and a microcontroller unit 11.

The automatic lubricator 3 is configured to adjust lubrication parameters based on a control signal 13 sent by the microcontroller unit 11 based on images of the machine taken by the visual recognition system 9. Advantageously, the lubrication parameters comprise the selection of the right lubricant, and/or the lubrication dispense rate, and/or the period of activity of the automatic lubricator 3.

The visual recognition system 9 comprises a camera and is configured to recognize a machine or a mechanical part of a machine by machine learning and with the assistance of a database, the database also including lubrication recommendations for the machine that will be sent as a control signal 13 by the microcontroller unit 11.

The visual recognition system 9 may or preferably may not be integrated into the automatic lubricator 3. The visual recognition system may be an external device or a phone comprising a camera and linked to the rest of the lubrication system. That way, an operator can take a picture or a video with his phone and send it to a signal receiver of the lubrication system 1. The machine may be recognized by its shape, and/or its dimensions, and/or by an identification plate and/or by any other means. The machine learning algorithm implemented in the visual recognition system 9 uses for example images available via an internet search engine.

The database may be stored in the microcontroller unit 11 or in a memory connected to the microcontroller unit 11, for example by a wireless connection. The database may also be stored on a distant server wirelessly accessible. For example, the visual recognition system 9 is a phone wirelessly connected to the database.

The visual recognition system 9 may also be configured to recognize the environment, preferably the location and/or the industry type, and/or the amount of dust and/or humidity by machine learning and with the assistance of a database, the database comprising the lubrication recommendations destined to be sent as a control signal 13 by the microcontroller unit 11. The location can be deduced by the visual recognition system 9 from the surroundings of the machine. The location may also be deduced by an access to an internet connection of the lubrication system 1 or by a phone of an operator linked to the lubrication system 1.

The industry type may be determined by the visual recognition system 9 from the materials surrounding the machine, for example cement or mineral processing. The determination of the environment of the machine permits to adapt the lubrication according to expected conditions in a specific industry, or location, or dust or humidity conditions.

Advantageously, the lubrication system 1 comprises a manual input module 15 configured to collect data entered manually by an operator in the manual input module 15, the control signal 13 sent by the microcontroller unit 11 depending on data collected by the manual input module 15. The manual input module 15 may or may not be integrated into the automatic lubricator 3. The manual input module 15 may be an external device or a phone comprising for example a keyboard and linked to the rest of the lubrication system 1. Preferably, the manual input module is a dedicated online interface. That way, an operator can enter manually some data with his phone and send it to a signal receiver of the lubrication system 1.

The data collected by the manual input module 15 may comprise a bearing type or a rotation speed of a bearing of the machine, or any other parameters, an operator thus being able to control the automatic lubricator 3 manually. Thus, data can be collected manually if it cannot be retrieved automatically via the visual recognition system 9.

According to one aspect of the disclosure, the lubrication system 1 comprises at least an internal sensor 17 destined to measure a backpressure applied on the lubricant, and/or a motor current applied on a motor of the automatic lubricator 3, and/or an ambient temperature around the lubrication system 1, and/or a battery voltage applied on a battery 7 powering the lubrication system 1, the control signal 13 sent by the microcontroller unit 11 depending on data collected by the internal sensor 17. Preferably, an internal sensor 17 is at least a temperature sensor such as a thermometer.

According to another aspect of the disclosure, the lubrication system 1 also comprises at least an external sensor 19 connected to the microcontroller unit 11 with a wireless connection or a wire connection, the external sensor 19 comprising a global positioning system measuring the location of the machine, and/or a vibration sensor positioned on the machine, and/or an ultrasonic sensor positioned on the machine, and/or a load measurement sensor positioned on the machine, the control signal 13 sent by the microcontroller unit 11 depending on data collected by the external sensor 19.

An internal sensor 17 is positioned inside the housing of the automatic lubricator 3 whereas an external sensor 19 is positioned outside the housing of the automatic lubricator 3. The combination of both internal and external sensors 17, 19 ensures the accuracy of the measurements made.

Additionally, the lubricator 3 may be configured to adjust lubrication parameters based on a control signal 13 sent by the microcontroller unit 11 depending on data collected by the internal sensor 17 and/or by the external sensor 19.

Optionally, the lubrication system 1 also comprises an RFID reader for reading information on the machine or on a bearing type stored in an RFID chip. The RFID reader may or may not be integrated into the automatic lubricator 3. The RFID reader may be an external device or a phone linked to the rest of the lubrication system 1. That way, an operator can get the RFID reader close to the machine with his phone and send the collected data to a signal receiver of the lubrication system 1.

Advantageously, the lubrication system 1 comprises a remote monitoring platform 21 wirelessly connected to the automatic lubricator 3 and the microcontroller unit 11. This wireless connectivity provides the necessary flexibility to implement this solution in a wide variety of assets, as well as the ability to monitor the status of the system remotely.

The lubrication method implemented by the lubrication system 1 for the lubrication of a machine first comprises a step E1 of launching a lubrication cycle, for example based on a pre-selected cycle or on data obtained from the visual recognition system 9 and/or the manual input module 15. This step E1 is the setup step.

In one particular embodiment, the lubrication system 1 needs to obtain a machine or bearing type, for example via the visual recognition system 9 or the manual input module 15. The bearing rotation speed can also be obtained via the visual recognition system 9 or the manual input module 15. A visual information about the contamination of the machine may also be obtained via the visual recognition system 9 or the manual input module 15. Finally, the geolocation is obtained by using an internet connection or a phone or a GPS.

At first, the lubrication parameters may not be perfectly adapted to the machine nor the surrounding conditions. hat is why the method comprises a step E2 of continuously adapting the lubrication cycle, for example with an updated setting every five minutes, based on data collected by the visual recognition system 9, and/or by the internal sensor 17, and/or the external sensor 19, and/or the manual input module 15, the lubrication cycle being thus adapted based on backpressure, and/or vibration readings, and/or load readings, and/or bearing housing temperature, and/or battery consumption, and/or humidity and/or data collected by the visual recognition system.

In one particular embodiment, the ambient temperature surrounding the automatic lubricator 3 is determined by an internal sensor 17, an operating temperature of the bearing housing may be determined via an external sensor 19, vibrations and/or ultrasonics may be determined by internal or external sensors 17, 19, the motor torque and the backpressure on application and the battery voltage are internally measured by the automatic lubricator 3, and the bearing load can be determined by an external sensor 19.

With the assistance of the visual recognition system 9 and/or the thermometer, and/or the determined geolocation and/or time zone, it is possible to implement an optional step E3 of reducing periodically the lubrication activity, corresponding for example to a temperature lower than a predefined threshold. The lubrication activity may be daily reduced during a particular time slot, for example nighttime.

This feature permits to stop the lubrication in cold temperature environment. A cold temperature environment may be observed during nighttime, or during a shade exposure. Indeed, cold lubricants are stiffer and require more energy to be distributed, this feature enabling the lubrication system 1 to preserve the battery 7 charge and extend the battery 7 life.

The visual recognition system 9 and/or the vibration sensor, and/or the thermometer may also identify cyclical operating conditions, like day and night, or temperature cycles, or periodical machine shutdown, the lubrication system 1 then adjusting its behavior by lubricating only when the necessary conditions are ensured and entering a pause mode when the conditions are not ensured.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved self-adjusting lubricating systems.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A lubrication system comprising:
an automatic lubricator configured to feed a controllable dose of lubricant to a lubrication point of a machine,
a visual recognition system configured to acquire at least one image of the machine, and
a microcontroller configured to communicate with the visual recognition system and with the automatic lubricator,
wherein the visual recognition system is configured to send at least one image signal to the microcontroller, the at least one image signal containing information about at least one appearance of the machine, and
wherein the microcontroller is configured to send at least one control signal to the automatic lubricator to adjust at least one lubrication parameter of the automatic lubricator based on the at least one control signal.

2. The lubrication system according to claim 1,
wherein the visual recognition system is configured to recognize the machine or a mechanical part of the machine, by machine learning and by access to a database, the database comprising lubrication recommendations for the machine.

3. The lubrication system according to claim 2,
wherein the visual recognition system is configured to recognize an environment of the machine and/or a location of the machine and/or an industry in which the machine is used, and/or an amount of dust and/or humidity in the environment of the machine by the machine learning and the database.

4. The lubrication system according to claim 2, including
a manual input module configured to receive data entered manually by an operator and to provide the data entered manually to the microcontroller,
wherein one of the at least one control signal sent by the microcontroller is based on the data received by the manual input module.

5. The lubrication system according to claim 4,
wherein the data entered manually comprises a bearing type and/or a rotation speed of a bearing of the machine.

6. The lubrication system according to claim 2,
including at least one first sensor configured to send a first sensor signal to the microcontroller, wherein the at least one sensor is selected from the group consisting of: a pressure sensor configured to measure a backpressure of controllable dose of the lubricant, a current sensor configured to measure an electrical current of the motor, a temperature sensor configured to measure an ambient temperature at the automatic lubricator or at the machine, and a voltage sensor configured to measure a voltage of a battery powering the automatic lubricator,
wherein the at least one control signal is based at least in part on the first sensor signal.

7. The lubrication system according to claim 6,
including at least one second sensor configured to send a second sensor signal to the microcontroller
wherein the at least one second sensor is selected from the group consisting of: a global positioning system configured to determine a geographic location of the machine, a vibration sensor configured to measure a vibration of the machine, an ultrasonic sensor on the machine, and a load sensor positioned on the machine, t
wherein the at least one control signal is based at least in part on the second sensor signal.

8. The lubrication system according to claim 7,
including a remote monitoring platform configured to communicate wirelessly with the microcontroller.

9. The lubrication system according to claim 2,
wherein a first one of the at least one lubrication parameter is a volume of the dose.

10. The lubrication system according to claim 2,
wherein the at least one lubrication parameter comprises an identification of the lubricant or a lubrication dispense rate or a period of activity of the automatic lubricator.

11. The lubrication system according to claim 1,
wherein the at least one lubrication parameter is a volume of the dose or a time of the dose.

12. A method comprising:
providing a lubrication system according to claim 7,
feeding the controllable dose of the lubricant to the lubrication point of the machine, and
adjusting the controllable dose of the lubricant in response to the at least one image signal and/or the at least one first sensor signal and/or the at least one second sensor signal.
